(19) United States
(12) Patent Application Publication
(10) Pub. No.: US 2012/0068988 A1
(43) Pub. Date: Mar. 22, 2012

(54) DATA LINE DRIVE CIRCUIT FOR DISPLAY DEVICES

(75) Inventors: Tomokazu KOJIMA, Osaka (JP); Munehiko OGAWA, Kyoto (JP); Yoshiyuki OTANI, Shiga (JP)

(73) Assignee: PANASONIC CORPORATION, Osaka (JP)

(21) Appl. No.: 13/269,110

(22) Filed: Oct. 7, 2011

Related U.S. Application Data
(63) Continuation of application No. PCT/JP2009/007031, filed on Dec. 18, 2009.

(30) Foreign Application Priority Data
Apr. 23, 2009 (JP) 2009-104733

(51) Int. Cl. G09G 5/00

(52) U.S. Cl. 345/211

(57) ABSTRACT

(M+N) drive circuits each perform impedance conversion on an input voltage to output the resultant voltage. A selector selects M drive circuits having a predetermined output voltage accuracy from the (M+N) drive circuits, supplies M display voltages to inputs of the selected M drive circuits, and outputs, as M drive voltages, outputs of the selected M drive circuits.

### CROSS-REFERENCE TO RELATED APPLICATIONS

This is a continuation of PCT International Application PCT/JP2009/007031 filed on Dec. 18, 2009, which claims priority to Japanese Patent Application No. 2009-104733 filed on Apr. 23, 2009. The disclosures of these applications including the specifications, the drawings, and the claims are hereby incorporated by reference in their entirety.

### BACKGROUND

The technology disclosed herein relates to data line drive circuits for display devices, such as liquid crystal panels, organic EL panels, etc.

A data line drive circuit for display devices, such as liquid crystal panels, etc. includes operational amplifiers for supplying respective voltages depending on display data to respective corresponding data lines. The supplied voltages are desired to have a uniform characteristic.

A liquid crystal drive circuit described in Japanese Patent Publication No. 2004-118212 (hereinafter referred to as Patent Document 1) will be described with reference to FIG. 11. The liquid crystal drive circuit 1 of FIG. 11 includes a latch address control circuit 10, latch circuits 20 and 30, a decoder circuit 40, an amplifier circuit 50, a gray-scale voltage generator circuit 60, and a setting register 70. The latch address control circuit 10 receives an enable signal 81, a display data clock 82, and a line clock 83, and outputs latch signals 91. The latch circuit 20 receives the latch signals 91 and input display data 84, and outputs data 92. The latch circuit 30 receives the line clock 83, and the data 92 from the latch circuit 20, and outputs data 93. The setting register 70 receives setting register setting data S86 and a setting register setting clock S87, and outputs setting data 88. The gray-scale voltage generator circuit 60 receives a reference voltage 85 and the setting data 88, and outputs gray-scale voltages 89. The decoder circuit 40 receives the data 93 from the latch circuit 30, and the gray-scale voltages 89, and outputs select voltages 94. The amplifier circuit 50 receives an offset signal 90, the select voltages 94, and the setting data 88, and outputs liquid crystal application voltages 95.

Next, output voltage offset adjustment and amplification factor adjustment in the liquid crystal drive circuit of Patent Document 1 will be described. FIG. 12 shows an internal configuration of a unit amplifier circuit (corresponding to one output of the amplifier circuit 50) included in the amplifier circuit 50 of FIG. 11. The unit amplifier circuit 500 includes a resistor (Ra) 51, a resistor (Rb) 52, a resistor (Rc) 53, a resistor (Rf) 54, and an operational amplifier 55. The resistor (Ra) 51 includes a plurality of resistors 511-511 connected together in series and a plurality of switches 512-512. The resistor (Rf) 54 includes a plurality of resistors 541-541 connected together in series and a plurality of switches 542-542. The output (Vin) 94 of the decoder circuit 40 and the offset signal (Vof) 90 are input via the resistor (Rb) 52 and the resistor (Rc) 53, respectively, to the non-inverting input terminal (+) of the operational amplifier 55. A voltage obtained by dividing the output (Vout) 95 of the operational amplifier 55 using the resistor (Rf) 54 and the resistor (Ra) 51 is input to the inverting input terminal (−) of the operational amplifier 55. The switches 512-512 and 542-542 of the resistors 51 and 54 are selectively turned on/off based on the setting data 88, whereby the resistors 51 and 54 can take desired resistor values.

### SUMMARY

In the liquid crystal drive circuit described in Patent Document 1, however, the output terminal of the operational amplifier 55 is connected via the resistors 54 and 51 to the ground in each unit amplifier circuit 500, and therefore, an extra current occurs which is obtained by dividing the output voltage Vout of the operational amplifier 55 using the resistors 54 and 51. In liquid crystal drive circuits which support recent large screens, such an extra current increases as the number of outputs increases. For example, if the amplifier circuit 50 includes about 1000 unit amplifier circuits 500, an extra current occurring in the amplifier circuit 50 is about 1000 times as large as an extra current occurring in one unit amplifier circuit. Here, if the resistance values of the resistors 511-511 and 541-541 are increased in order to reduce the extra current, the circuit area of the amplifier circuit 50 increases substantially in proportion to the resistance values of the resistors 511-511 and 541-541, so that the size of the liquid crystal drive circuit increases, resulting in an increase in cost.

Also, in the liquid crystal drive circuit of Patent Document 1, fluctuation in temperature or power supply voltage causes fluctuation in offset voltage. For example, when the offset voltage is adjusted, the resistance values of the resistors 51 and 54 are adjusted so that (V1+V2+V3)<(acceptable offset voltage range), where V1 is the offset voltage of the operational amplifier 55 of FIG. 12, V2 is a voltage adjusted by the resistors 511-511 and 541-541, and V3 is a voltage generated by the on resistances of the switches 512-512 and 542-542. However, conventionally, it is often that the operational amplifier 55 includes a transistor, and the resistors 511-511 and 541-541 are made of a material (polysilicon, diffusion, etc.) which is different from that of the transistor. The switches 512-512 and 542-542 each include a transistor having a transistor size which is different from that of the operational amplifier 55. In other words, in the liquid crystal drive circuit of Patent Document 1, the operational amplifier 55, the resistors 511-511 and 541-541, and the switches 512-512 and 542-542 have different temperature coefficients, and therefore, even if the offset voltage is adjusted at a temperature, the voltages V1, V2, and V3 each drift at a different temperature, so that the offset voltage fluctuates.

The present disclosure describes implementations of a data line drive circuit which provides a plurality of drive voltages having a uniform characteristic while the increase in circuit area is reduced or prevented.

According to one aspect of the present disclosure, a data line drive circuit for outputting M drive voltages for driving M data lines of a display device, where M is an integer of two or more, includes (M+N) drive circuits each configured to perform impedance conversion on an input voltage and output the resultant voltage, where n is an integer of one or more, and a selector configured to select M drive circuits having a predetermined output voltage accuracy from the (M+N) drive circuits, supply M display voltages based on image data to be displayed on the display device to inputs of the selected M drive circuits, and output, as the M drive voltages, outputs of the selected M drive circuits. The (M+N) drive circuits include (M+N) differential amplifier transistor pairs, M active loads each configured to serve as an active load for an operational amplifier, and M output driver/current mirror sections each configured to serve as an output circuit for an operational amplifier and as a current mirror circuit configured to input a bias to the corresponding differential amplifier transistor pair. M differential amplifier transistor pairs selected from the (M+N) differential amplifier transistor pairs by the selector, the M active loads, and the M output driver/current mirror sections form M negative feedback operational amplifiers.

According to another aspect of the present disclosure, a data line drive circuit for outputting M drive voltages for driving M data lines of a display device, where M is an integer of two or more, includes (M+N) drive circuits each configured to perform impedance conversion on an input voltage and output the resultant voltage, where n is an integer of one or more, and a selector configured to select M drive circuits having a predetermined output voltage accuracy from the (M+N) drive circuits, supply M display voltages based on image data to be displayed on the display device to inputs of the selected M drive circuits, and output, as the M drive voltages, outputs of the selected M drive circuits. The (M+N) drive circuits include (M+N) differential amplifiers each configured to serve as a differential amplifier for an operational amplifier, and M output driver/current mirror sections each configured to serve as an output circuit for an operational amplifier and as a current mirror circuit configured to input a bias to the corresponding differential amplifier transistor pair. M differential amplifiers selected from the (M+N) differential amplifiers by the selector and the M output driver/current mirror sections form M negative feedback operational amplifiers.

Note that, in the data line drive circuit, operation of N of the (M+N) drive circuits which have not been selected by the selector may be stopped.

Also, in the data line drive circuit, the (M+N) drive circuits may be successively operated to select the M drive circuits having the predetermined output voltage accuracy.

According to another aspect of the present disclosure, a display device includes the data line drive circuit, and a display panel configured to be driven based on the M drive voltages of the data line drive circuit.

According to the data line drive circuit, a plurality of drive voltages can be caused to have a uniform characteristic while an increase in circuit area is reduced or prevented. Also, a range within which the offset voltage of an output terminal is reduced can be set, depending on the performance level of a display device, to control a semiconductor device.

### BRIEF DESCRIPTION OF THE DRAWINGS

FIG. 1A is a block diagram showing an example configuration of a data line drive circuit according to a first embodiment.

FIG. 1B is a diagram for describing a relationship between a data line drive circuit and a display panel.

FIG. 2 is a diagram showing an example configuration of an amplifier circuit of FIG. 1.

FIG. 3 is a diagram showing an example configuration of an amplifier circuit according to a first variation of the first embodiment.

FIG. 4A is a diagram showing an example configuration of an active load of FIG. 3.

FIG. 4B is a diagram showing an example configuration of an output driver/current mirror section of FIG. 3.

FIG. 5 is a diagram showing an example configuration of an amplifier circuit according to a second variation of the first embodiment.

FIG. 6A is a diagram showing an example configuration of a differential amplifier of FIG. 5.

FIG. 6B is a diagram showing an example configuration of an output driver/current mirror section.

FIG. 7 is a diagram showing an example configuration of an amplifier circuit according to a second embodiment.

FIG. 8A is a diagram showing an example configuration of a defective amplifier detection circuit of FIG. 7.

FIG. 8B is a diagram showing another example configuration of a defective amplifier detection circuit of FIG. 7.

FIG. 9A is a block diagram showing an example configuration of a display device according to a third embodiment.

FIG. 9B is a diagram showing an example configuration of a pixel circuit of FIG. 9A.

FIGS. 10A and 10B are diagrams for describing what images displayed on the display device of FIG. 9A are like.

FIG. 11 is a block diagram schematically showing a configuration of a conventional liquid crystal drive circuit.

FIG. 12 is a diagram schematically showing a configuration corresponding to out output of an amplifier circuit of the liquid crystal drive circuit of FIG. 11.

### DETAILED DESCRIPTION

Embodiments of the present disclosure will be described in detail hereinafter with reference to the accompanying drawings. The same or similar parts are identified by the same reference characters in the drawings, and the description thereof may not be repeated.

### First Embodiment

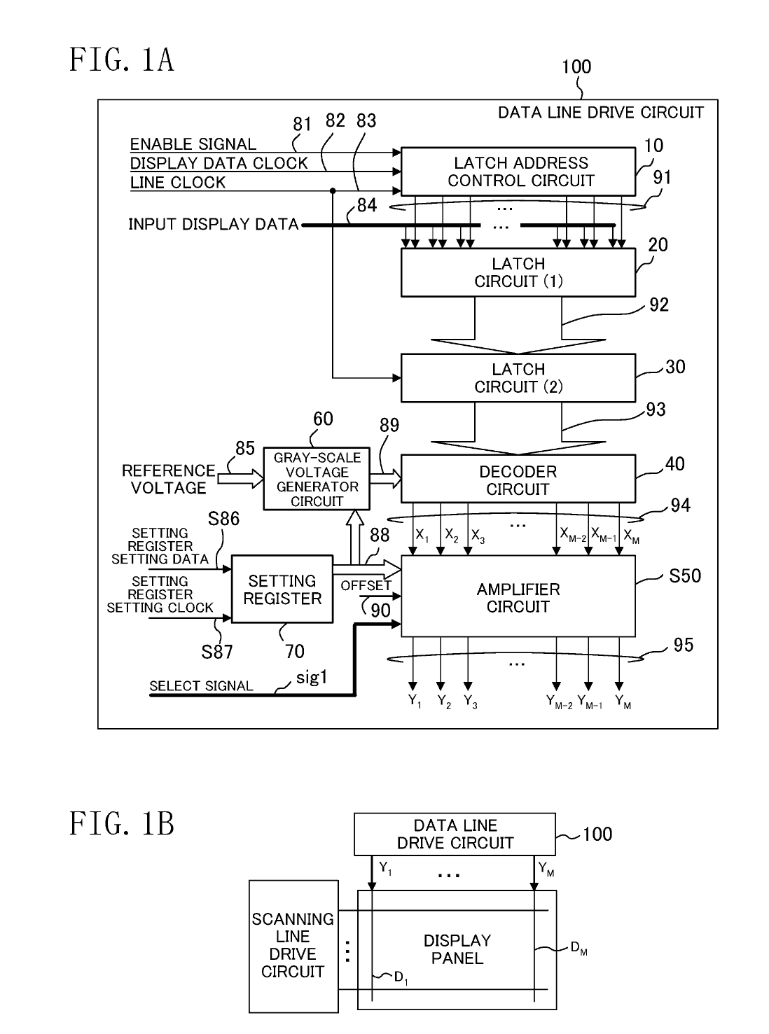

FIG. 1A shows an example configuration of a data line drive circuit 100 according to a first embodiment. As shown in FIG. 1B, the data line drive circuit 100 outputs M drive voltages Y₁-Y_{M} for driving M data lines D₁-D_{M} of a display panel, such as a liquid crystal panel, an organic EL panel, etc., where M is an integer of two or more. The data line drive circuit 100 includes a latch address control circuit 10, latch circuits 20 and 30, a decoder circuit 40, an amplifier circuit S50, a gray-scale voltage generator circuit 60, and a setting register 70.

The latch address control circuit 10 receives an enable signal 81, a display data clock 82, and a line clock 83, and outputs latch signals 91. The latch circuit 20 receives image data (digital signal) which is to be displayed on the display panel, as input display data 84, and latches the input display data 84 in synchronization with the latch signals 91 from the latch address control circuit 10. The latch circuit 30 latches data 92 latched by the latch circuit 20 in synchronization with the line clock 83. The decoder circuit 40 generates M display voltages X₁-X_{M} based on data 93 latched by the latch circuit 30 and gray-scale voltages 89 from the gray-scale voltage generator circuit 60. The amplifier circuit S50 receives the M display voltages X₁-X_{M}, and performs impedance conversion on the display voltage X₁-X_{M} to output the drive voltages Y₁-Y_{M} so that the M data lines (loads) D₁-D_{M} can be driven. The setting register 70 receives setting register setting data S86 and a setting register setting clock S87, and outputs setting data 88. The gray-scale voltage generator circuit 60 receives a reference voltage 85 and the setting data 88, and outputs gray-scale voltages 89.

[Amplifier Circuit]

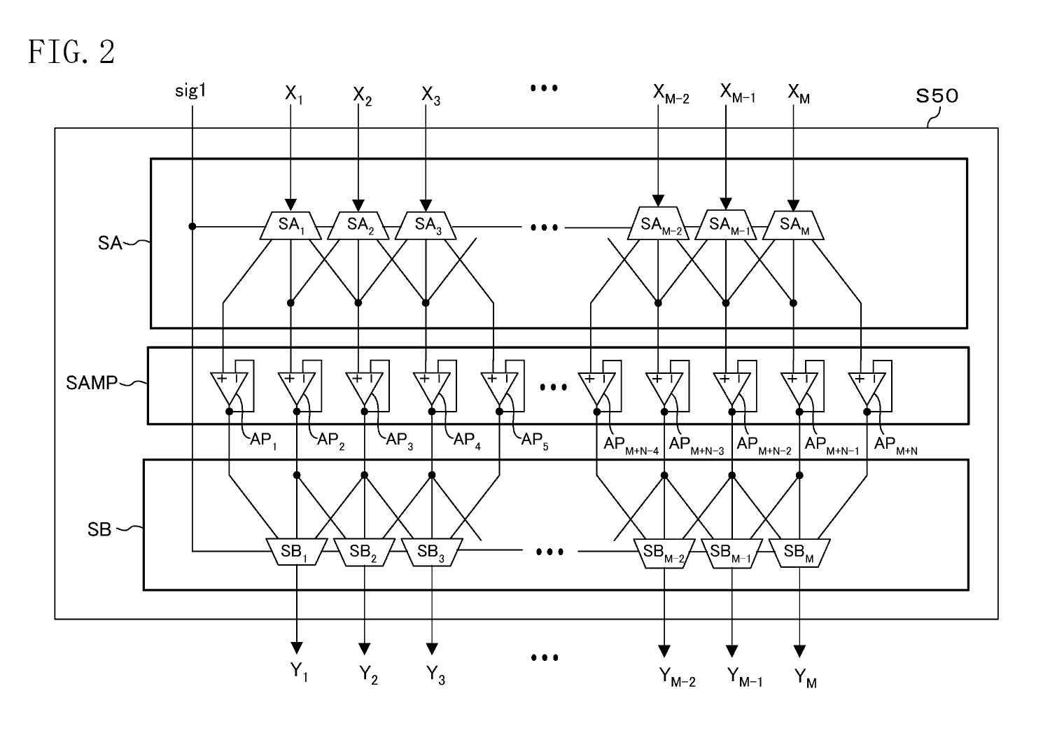

FIG. 2 shows an example configuration of the amplifier circuit S50 of FIG. 1A. The amplifier circuit S50 includes an input selector SA, a drive amplifier SAMP, and an output selector SB. Note that, in FIG. 2, for ease of understanding, it is assumed that N=2.

The input selector SA includes M selectors SA₁-SA_{M}. The selectors SA₁-SA_{M} correspond to the display voltages X₁-X_{M}, respectively. The i-th selector SAᵢ (i=1, . . . , M) receives the i-th display voltage Xᵢ (i=1, . . . , M) corresponding to the selector SAᵢ. The selectors SA₁-SA_{M} are each a selector having one input and (N+1) outputs. The selector SAᵢ (i=1, . . . , M) selectively outputs the display voltage Xᵢ (i=1, . . . , M) from one of the (N+1) output terminals of the selector SAᵢ in response to a select signal sig1.

The drive amplifier SAMP includes (M+N) operational amplifiers AP₁-AP_{M+N} (N is an integer of one or more) each configured as a voltage follower.

The output selector SB includes M selectors SB₁-SB_{M}. The selectors SB₁-SB_{M} correspond to the M data lines D₁-D_{M} of the display panel, respectively. The i-th selector SBᵢ (i=1, . . . , M) outputs the i-th drive voltage Yᵢ (i=1, . . . , M) which is used to drive the i-th data line Dᵢ (i=1, . . . , M) corresponding to the selector SBᵢ. The selectors SB₁-SB_{M} are each a sector having (N+1) inputs and one output. The selector SBᵢ (i=1, . . . , M) selectively outputs, as the i-th drive voltage Yᵢ, a voltage input to one of the (N+1) input terminals of the selector SBᵢ in response to the select signal sig1.

One of the (N+1) output terminals of the i-th selector SA, (i=1, . . . , M) of the input selector SA is connected to the non-inverting input terminal (+) of the i-th operational amplifier APᵢ (i=1, . . . , M), while the remaining N output terminals are connected to the non-inverting input terminals (+) of the (i+1)th to (i+N)th operational amplifiers APᵢ₊₁-AP_{i+N} (i=1, . . . , M), respectively.

One of the (N+1) input terminals of the i-th selector SBᵢ (i=1, . . . , M) of the output selector SB is connected to the output terminal of the i-th operational amplifier APᵢ (i=1, . . . , M), while the remaining N input terminals are connected to the output terminals of the (i+1)th to (i+N)th operational amplifiers APᵢ₊₁-AP_{i+N} (i=1, . . . , M), respectively.

[Number of Operational Amplifiers]

The number (M+N) of the operational amplifiers AP₁-AP_{M+N} included in the drive amplifier SAMP of FIG. 2 is greater by N than the number (M) of the drive voltages Y₁-Y_{M}. The difference N will be described in detail.

An output voltage accuracy (ΔV), a yield (σ), and a process variation of the drive amplifier SAMP have the following relationship. If the output voltage accuracy (ΔV) of the drive amplifier SAMP is set to be high, then when a high yield (σ) is required, the process variation needs to be considerably small. Moreover, in order to provide an amplifier circuit having a higher accuracy required for a display device having a large screen and high definition, the data line drive circuit 100 has the following features. Specifically, the yield (σ) of the drive amplifier SAMP is previously estimated from the output voltage accuracy (ΔV), and N redundant operational amplifiers are prepared, depending on the yield (σ). One or more operational amplifiers which do not have a predetermined output voltage accuracy are replaced with one or more of the N redundant operational amplifiers, so that the output voltage accuracy (ΔV) of the drive amplifier SAMP falls within a predetermined range, and therefore, the yield can be ensured even if a process variation occurs. The output voltage accuracy (ΔV) and process variation of the drive amplifier SAMP are determined by the threshold voltage variation (ΔVt) of a transistor and the amplification factor of a differential amplifier and an active load. The amplification factor of the differential amplifier and the active load can be previously set so that the predetermined output voltage accuracy (ΔV) is obtained. However, it is considerably difficult to address the transistor threshold voltage variation (ΔVt) caused by the transistor process variation by circuit design or circuit scheme. The threshold voltage variation (ΔVt) is represented by:

ΔVt=A×tox/(√WL) (1)

where L is the length of the transistor, W is the width of the transistor, tox is the thickness of the gate oxide film, and A is a proportional coefficient.

Sizes (W and L) of the transistor which can ensure a yield may be determined based on Expression 1.

However, there is a limit on the estimation of the variation and the yield using such a technique. The variations in the drive voltages Y₁-Y_{M} of the drive amplifier SAMP inherently occur due to a systematic offset caused by design limitations and a random offset caused by a process variation. The systematic offset caused by design limitations may be reduced by modifying circuit design or circuit scheme, such as the technique of determining a circuit constant, etc. However, the random offset occurs at some probability in some processing step or in a mask forming step. Therefore, even if the transistor sizes (W and L) are determined based on Expression 1, the threshold voltage may vary at some frequency.

For example, if the transistor sizes (W and L) are set so that the yield (σ) of one operational amplifier included in the drive amplifier SAMP is 99.7%, then when the number of operational amplifiers included in the drive amplifier SAMP is 1000, there are three defective terminals (i.e., three operational amplifiers) of 1000 output terminals of the drive amplifier SAMP. In order to eliminate the defects, the transistor sizes (W and L) may be further increased to increase the yield or the yield itself may be reduced (the quantity of chips is increased). In either case, the cost increases. Here, if 10 redundant operational amplifiers are prepared as redundant circuits for the drive amplifier SAMP, i.e., these operational amplifiers are used to replace three operational amplifiers, the probability of occurrence of a defect can be reduced to (1-99.7/100)⁸, which is a yield of almost 100% in practical use. In this case, the redundant operational amplifiers (here, 10) account for only 1% of the operational amplifiers (here, 1000) included in the drive amplifier SAMP, and therefore, the increase in cost is also only about 1%.

The transistor sizes (W and L) may be reduced in view of the use of the redundant operational amplifiers, whereby the circuit area of the drive amplifier SAMP can be further reduced. For example, if the transistor sizes of the operational amplifier are set to W′ (width)=W/2 and L (length)=L (unchanged), the circuit area of the drive amplifier SAMP can be reduced by about 50%. Note that, in this case, the yield of the operational amplifier is 96.4%. There is a possibility that 36 defective operational amplifiers occur per 1000 operational amplifiers. In order to replace the defects, 50 redundant operational amplifiers for replacement may be provided for 1000 operational amplifiers. The redundant operational amplifiers may be manufactured in a manner similar to that of the other operational amplifiers. Therefore, if the yield of the operational amplifier is 96.4%, 48 or more of 50 redundant operational amplifiers can be ensured to be normal (non-defective) operational amplifiers. Thus, by preparing redundant operational amplifiers for replacement, the output voltage accuracy of the drive amplifier SAMP can be ensured although the area of the drive amplifier SAMP increases by as small as 0.5%. In other words, the amplifier circuit S50 having a high accuracy, a small area, low power consumption, and low cost can be provided.

As described above, the number (N) of redundant operational amplifiers is previously set, assuming a defective accuracy, and (M+N) operational amplifiers AP₁-AP_{M+N} the number of which is larger by N than the number (M) of the drive voltages Y₁-Y_{M} are provided in the drive amplifier SAMP. Note that unused operational amplifiers (e.g., defective operational amplifiers etc.) of the (M+N) operational amplifiers AP₁-AP_{M+N} may be controlled so that the operation of the unused operational amplifiers is stopped. Such a control can reduce or prevent an increase in power consumption.

[Operation]

Next, operation of the data line drive circuit 100 of the first embodiment will be described.

Initially, it is checked whether or not each of the operational amplifiers AP₁-AP_{M+N} of the drive amplifier SAMP has a predetermined output voltage accuracy (the output error of the operational amplifier falls within a predetermined error range), to select M operational amplifiers from operational amplifiers having the predetermined output voltage accuracy. The selected M operational amplifiers are assigned to the M selectors SAᵢ-SA_{M} so that the different operational amplifiers are assigned to the respective corresponding selectors SAᵢ-SA_{M}. Such selection is possible because the number (N) of redundant operational amplifiers is previously set, assuming a defective accuracy, as described above. The addresses (select values) of the selected M operational amplifiers are stored in a storage device (e.g., an EEPROM, a flash memory, etc.) provided outside the data line drive circuit 100.

Next, the addresses (select values) stored in the storage device are input as the select signal sig1 having M×(1+log₂(N+1)) bits to the input selector SA and the output selector SB. The i-th selector SAᵢ (i=1, . . . , M) of the input selector SA outputs the i-th display voltage Xᵢ (i=1, . . . , M) to the non-inverting input terminal (+) of one of the operational amplifiers APᵢ-AP_{i+N} (i=1, . . . , M) that is specified based on the select signal sig1. The i-th selector SBᵢ (i=1, . . . , M) of the output selector SB outputs, as the i-th drive voltage Y, (i=1, . . . , M), the output of one of the operational amplifiers APᵢ-AP_{i+N} (i=1, . . . , M) that is specified based on the select signal sig1.

Thus, M operational amplifiers are selected from the (M+N) operational amplifiers AP₁-AP_{M+N} by the input selector SA and the output selector SB. Note that non-selected ones (operational amplifiers which are not selected by the input selector SA and the output selector SB) of the operational amplifiers APᵢ-AP_{i+N} (i=1, . . . , M) may be turned off (stopped).

As described above, M operational amplifiers having a predetermined output voltage accuracy (an output voltage accuracy required for the data line drive circuit 100) are selected from the (M+N) operational amplifiers AP₁-AP_{M+N} and are used, whereby the accuracy of the M drive voltages Y₁-Y_{M} can be increased.

Moreover, unlike conventional techniques (Patent Document 1 etc.), a resistor etc. is not used to increase the accuracy, and therefore, an extra current does not occur. Because it is not necessary to add a resistor, the increase in area can be reduced to a greater extent than those of conventional techniques. Moreover, the power of a non-selected operational amplifier can be reduced to several picoamperes or less (substantially zero). Thus, the increase in power consumption and area which is caused by addition of a resistor can be prevented.

The selection of M operational amplifiers having a predetermined output voltage accuracy from the (M+N) operational amplifiers AP₁-AP_{M+N} means selection of operational amplifiers including transistors having a small mismatch. Therefore, variations caused by temperature or power supply are also variations of similar transistors, and therefore, substantially do not occur. As a result, variations in offset voltage caused by variations in power supply voltage or temperature can be reduced.

The (M+N) operational amplifiers AP₁-AP_{M+N} each configured as a voltage follower are described as an example drive circuit only for illustrative purposes. Alternatively, (M+N) other negative-feedback circuits (e.g., an inverting amplifier, a non-inverting amplifier, etc.) may be used.

(First Variation of First Embodiment)

In the first embodiment, N redundant operational amplifiers are prepared in the drive amplifier SAMP, and M operational amplifiers having a predetermined output voltage accuracy are selected from the (M+N) operational amplifiers AP₁-AP_{M+N}. In a first variation of the first embodiment, N redundant differential amplifier transistor pairs are previously prepared in the drive amplifier SAMP instead of providing redundant operational amplifiers themselves, and a control technique and a selection technique similar to those of the first embodiment are employed.

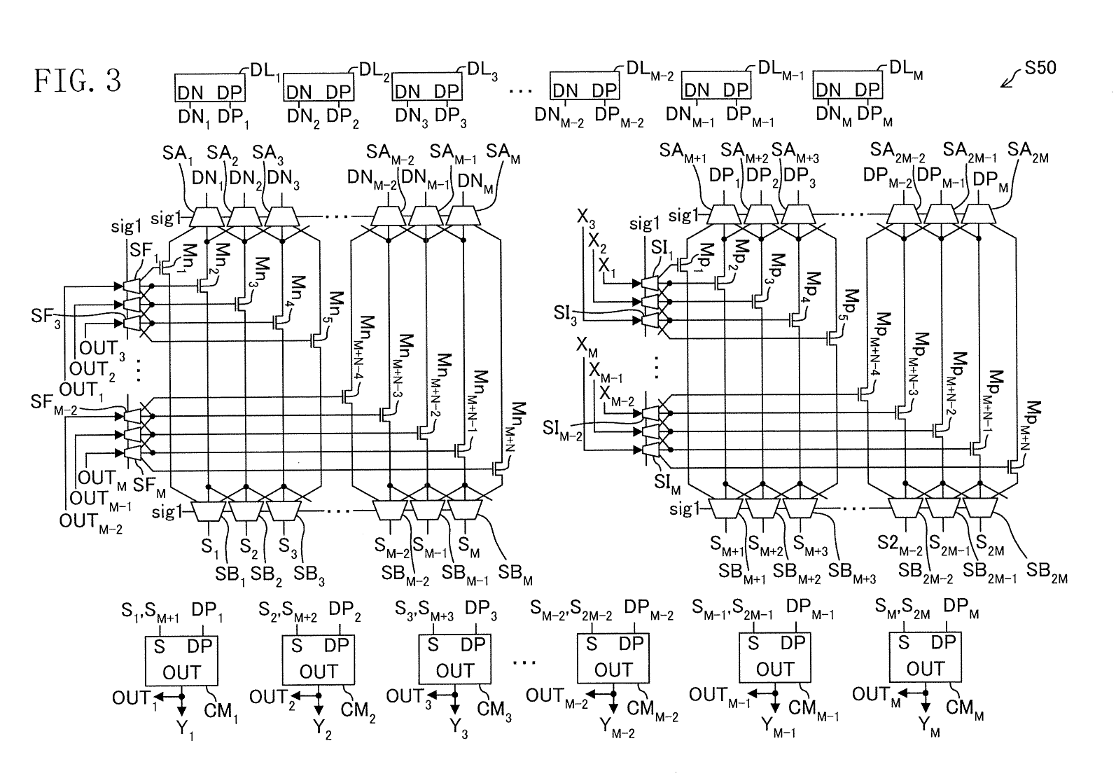

FIG. 3 shows a configuration of an amplifier circuit S50 according to the first variation of the first embodiment. The amplifier circuit S50 includes 2M selectors SA₁-SA_{2M}, 2M selectors SB₁-SB_{2M}, M selectors SI₁-SI_{M}, M selectors SF₁-SF_{M}, (M+N) non-inverting input transistors Mp₁-Mp_{M+N}, (M+N) inverting input transistors Mn₁-Mn_{M+N}, M active loads DL₁-DL_{M}, and M output driver/current mirror sections CM₁-CM_{M}. Note that, similar to the first embodiment, in FIG. 3, a case where N=2 is shown for ease of understanding.

The i-th non-inverting input transistor Mpᵢ (i=1, . . . , M+N) and the i-th inverting input transistor Mnᵢ (i=1, . . . , M+N) form the i-th differential amplifier transistor pair (Mpᵢ, Mnᵢ). In other words, in the amplifier circuit S50 of FIG. 3, the (M+N) differential amplifier transistor pairs (Mp₁, Mn₁)-(Mp_{M+N}, Mn_{M+N}) are provided, the number of which is larger by N than the number (M) of the drive voltages Y₁-Y_{M}.

The selectors SI₁-SI_{M} correspond to the display voltages X₁-X_{M}, respectively. The i-th selector SIᵢ (i=1, . . . , M) receives the i-th display voltage Xᵢ (i=1, . . . , M) corresponding to the selector SIᵢ. The selectors SI₁-SI_{M} are each a selector having one input and (N+1) outputs. The (N+1) output terminals of the selector (i=1, . . . , M) are connected to the gate terminals of the i-th to (i+N)th non-inverting input transistors Mpᵢ-Mp_{i+N} (i=1, . . . , M), respectively. The selector (i=1, . . . , M) selectively outputs the display voltage Xᵢ (i=1, . . . , M) from one of the (N+1) output terminals of the selector SIᵢ in response to a select signal sig1.

The selectors SF₁-SF_{M} correspond to output voltages OUT₁-OUT_{M} of the output driver/current mirror sections CM₁-CM_{M}, respectively. The i-th selector SFᵢ (i=1, . . . , M) receives the i-th output voltage OUTᵢ (i=1, . . . , M) corresponding to the selector SFᵢ. The selectors SF₁-SF_{M} are each a selector having one input and (N+1) outputs. The (N+1) output terminals of the selector SFᵢ (i=1, . . . , M) are connected to the gate terminals of the i-th to (i+N)th inverting input transistors Mnᵢ-Mn_{i+N} (i=1, . . . , M), respectively. The selector SFᵢ (i=1, . . . , M) selectively outputs the output voltage OUTᵢ (i=1, . . . , M) corresponding to the selector SFᵢ from one of the (N+1) output terminals of the selector SFᵢ in response to the select signal sig1.

Active loads DL₁-DL_{M} are each an active load circuit having an active load function for an operational amplifier. The output driver/current mirror sections CM₁-CM_{M} each include an output circuit for an operational amplifier and a current mirror circuit for applying a bias (bias current) to a differential amplifier transistor pair.

The selectors SA₁-SA_{M} correspond to the active loads DL₁-DL_{M}, respectively. The i-th selector SAᵢ (i=1, . . . , M) receives an output voltage DNᵢ (i=1, . . . , M) of the i-th active load DLᵢ corresponding to the selector SAᵢ. The selectors SA₁-SA_{M} are each a selector having one input and (N+1) outputs. The (N+1) output terminals of the selector SAᵢ (i=1, . . . , M) are connected to the drain terminals of the i-th to (i+N)th inverting input transistors Mnᵢ-Mn_{i+N} (i=1, . . . , M), respectively. The selector SAᵢ (i=1, . . . , M) selectively outputs the output voltage DNᵢ (i=1, . . . , M) of the active load DLᵢ from one of the (N+1) output terminals of the selector SAᵢ in response to the select signal sig1.

The selector SA_{M+1}-SA_{2M} correspond to the active loads DL₁-DL_{M}, respectively, and the j-th selector SAⱼ (j=M+1, . . . , 2M) receives an output voltage DPᵢ (i=1, . . . , M) of the i-th the active load DLᵢ corresponding to the selector SAⱼ. The selectors SA_{M+1}-SA_{2M} are each a selector having one input and (N+1) outputs. The (N+1) output terminals of the selector SAⱼ (j=M+1, . . . , 2M) are connected to the drain terminals of the i-th to (i+N)th non-inverting input transistors Mpᵢ-Mp_{i+N} (i=1, . . . , M), respectively. The selector SAⱼ (j=M+1, . . . , 2M) selectively outputs the output voltage DPᵢ (i=1, . . . , M) of the active load DLᵢ from one of the (N+1) output terminals of the selector SAⱼ in response to the select signal sig1.

The selectors SB₁-SB_{M} correspond to the selectors SA₁-SA_{M}, respectively. The selectors SB₁-SB_{M} are each a selector having (N+1) inputs and one output. The (N+1) input terminals of the i-th selector SBᵢ (i=1, . . . , M) are connected to the source terminals of the i-th to (i+N)th inverting input transistors Mnᵢ-Mn_{i+N} (i=1, . . . , M), respectively. The selector SBᵢ (i=1, . . . , M) selectively connects one of the (N+1) input terminals of the selector SBᵢ to a terminal S of the i-th output driver/current mirror section CMᵢ (i=1, . . . , M) in response to the select signal sig1.

The selectors SB_{M+1}-SB_{2M} correspond to the selectors SA_{M+1}-SA_{2M}, respectively. The selectors SB_{M+1}-SB_{2M} are each a selector having (N+1) inputs and one output. The (N+1) input terminals of the j-th selector SBⱼ (j=M+1, . . . , 2M) are connected to the source terminals of the i-th to (i+N)th non-inverting input transistors Mpᵢ-Mp_{i+N} (i=1, . . . , M), respectively. The selector SBⱼ (j=M+1, . . . , 2M) selectively connects one of the (N+1) input terminals of the selector SBⱼ to the terminal S of the i-th output driver/current mirror section CMᵢ (i=1, . . . , M) in response to the select signal sig1.

The output voltage Sᵢ (i=1, . . . , M) of the i-th selector SBᵢ (i=1, . . . , M) and the output voltage S_{M+i} (i=1, . . . , M) of the (M+i)th selector SB_{M+i} (i=1, . . . , M) are supplied to the input terminal S of the i-th output driver/current mirror section CMᵢ (i=1, . . . , M). The output voltage DPᵢ (i=1, . . . , M) of the i-th the active load DLᵢ is supplied to an input terminal DP of the i-th output driver/current mirror section CMᵢ (i=1, . . . , M).

[Active Load]

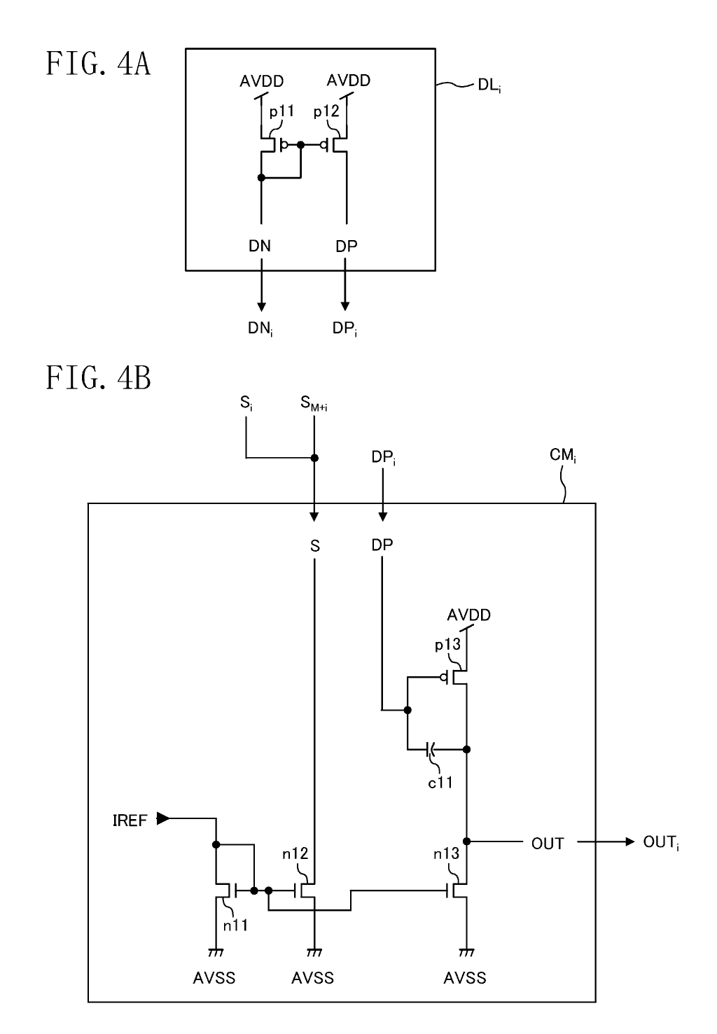

FIG. 4A shows an example configuration of the active load DLᵢ (i=1, . . . , M) of FIG. 3. The active load DLᵢ includes a pair of a diode-connected P-channel transistor p11 and a P-channel transistor p12. The active load DLᵢ operates so that a current flowing between a power supply node to which a power supply voltage AVDD is applied and a terminal DN is equal to a current flowing between a power supply node to which a power supply voltage AVDD is applied and a terminal DP. The terminals DP and DN of the active load DLᵢ are connected to one of the non-inverting input transistors Mp₁-Mp_{M+N} and one of the inverting input transistors Mn₁-Mn_{M+N}, respectively, to form a differential amplifier.

[Output Driver/Current Mirror Section]

FIG. 4B shows an example configuration of the output driver/current mirror section CMᵢ (i=1, . . . , M) of FIG. 3. The output driver/current mirror section CMᵢ includes a diode-connected N-channel transistor n11, an N-channel transistor n12, an N-channel transistor n13, a P-channel transistor p13, and a phase compensation capacitor c11. The N-channel transistor n11 is connected between a terminal IREF to which a bias current is input and a ground node to which a ground voltage AVSS is input. The N-channel transistor n12 supplies a bias current to the non-inverting input transistors Mp₁-Mp_{M+N} and the inverting input transistors Mn₁-Mn_{M+N} which form differential amplifier pairs, based on the gate voltage of the N-channel transistor n11. The N-channel transistor n13 supplies a bias current to an output terminal OUT based on the gate voltage of the N-channel transistor n11. The P-channel transistor p13 is connected between the output terminal OUT and a power supply node to which a power supply voltage AVDD is input. The P-channel transistor p13 is an output transistor. By connecting the gate terminal of the P-channel transistor p13 to a terminal DP, the P-channel transistor p13 is caused to function as an output transistor for a differential amplifier. The phase compensation capacitor c11 is connected between the gate terminal of the P-channel transistor p13 and the output terminal OUT. When two or more amplifiers, such as the differential amplifier and the output section (the P-channel transistor p13 and the N-channel transistor n13), are connected together, the phase compensation capacitor c11 is required in order to ensure stability. The phase compensation capacitor c11 has a capacitance of about several picofarads. Typically, on a semiconductor device, the area of a capacitor is often larger than those of other components.

[Operation]

Next, operation of the amplifier circuit S50 of FIG. 3 will be described. Here, it is assumed that, of the non-inverting input transistors Mp₁-Mp_{M+N} and the inverting input transistors Mn₁-Mn_{M+N}, the transistors Mp₂ and Mn₂ are defective (i.e., have a large variation in the threshold (Vt)), and the other transistors do not have a fabrication variation.

When the data line drive circuit 100 including the amplifier circuit S50 of FIG. 3 is activated, the select signal sig1 is initially input to the selectors SA₁, SB₁, SF₁, SA_{M+1}, SB_{M+1}, and SI₁ so that the first differential amplifier transistor pair (Mp₁, Mn₁) is initially selected. As a result, the active load DL₁, the differential amplifier transistor pair (Mp₁, Mn₁), and the output driver/current mirror section CM₁ can operate in a manner similar to that of the operational amplifier AP₁ of FIG. 2. In this situation, when the display voltage X₁ is input to the selector SI₁, the active load DL₁, the differential amplifier transistor pair (Mp₁, Mn₁), and the output driver/current mirror section CM₁ perform impedance conversion on the display voltage X₁ to output, as the drive voltage Y₁, a voltage having a voltage level equal to that of the display voltage X₁. Here, because the transistors Mp₁ and Mn₁ are not defective, the drive voltage Y₁ having a value substantially equal to the expected value is obtained. Thereafter, it is determined to select the differential amplifier transistor pair (Mp₁, Mn₁), and the address (select value) of the differential amplifier transistor pair (Mp₁, Mn₁) is stored in an external storage device so that the differential amplifier transistor pair (Mp₁, Mn₁) is selected by the selectors SA₁, SB₁, SF₁, SA_{M+1}, SB_{M+1}, and SI₁.

Next, the select signal sig1 is input to the selectors SA₂, SB₂, SF₂, SA_{M+2}, SB_{M+2}, and SI₂ so that the second differential amplifier transistor pair (Mp₂, Mn₂) is selected. As a result, the active load DL₂, the transistors Mp₂ and Mn₂, and the output driver/current mirror section CM₂ can operate in a manner similar to that of the operational amplifier AP₂ of FIG. 2. In this situation, however, even if the display voltage X₂ is input to the selector SI₂, the active load DL₂, the differential amplifier transistor pair (Mp₂, Mn₂), and the output driver/current mirror section CM₂ cannot normally perform impedance conversion on the display voltage X₂, and cannot output the drive voltage Y₂ having a level equal to that of the display voltage X₂. This is because the transistors Mp₂ and Mn₂ are defective.

In this case, the select signal sig1 is also input to the selectors SA₂, SB₂, SF₂, SA_{M+2}, SB_{M+2}, and SI₂ so that the third differential amplifier transistor pair (Mp₃, Mn₃) is selected. As a result, the active load DL₂, the differential amplifier transistor pair (Mp₃, Mn₃), and the output driver/current mirror section CM₂ can operate in a manner similar to that of the operational amplifier AP₃ of FIG. 2. In this situation, when the display voltage X₂ is input, the active load DL₂, the differential amplifier transistor pair (Mp₃, Mn₃), and the output driver/current mirror section CM₂ perform impedance conversion on the display voltage X₂ to output, as the drive voltage Y₂, a voltage having a voltage level equal to that of the display voltage X₂. Here, because the transistors Mp₃ and Mn₃ are not defective, the drive voltage Y₂ having a value substantially equal to the expected value is obtained. Thereafter, it is determined to select the differential amplifier transistor pair (Mp₃, Mn₃), and the address (select value) of the differential amplifier transistor pair (Mp₃, Mn₃) is stored in an external storage device so that the differential amplifier transistor pair (Mp₃, Mn₃) is selected by the selectors SA₂, SB₂, SF₂, SA_{M+2}, SB_{M+2}, and SI₂.

By repeatedly performing such operation, M addresses excluding those of defective transistors can be stored in a storage device. When displaying, only M addresses excluding those of defective transistors are input, whereby M operational amplifiers which do not have a variation in characteristic can be configured.

As described above, M differential amplifier transistor pairs having a predetermined output voltage accuracy are selected from (M+N) differential amplifier transistor pairs (Mp₁, Mn₁)-(Mp_{M+N}, Mn_{M+N}) to form M operational amplifiers, whereby the accuracies of M output voltages Y₁-Y_{M} can be increased.

Moreover, unlike conventional techniques, a resistor etc. is not used to increase the accuracy, and therefore, an extra current does not occur. Because it is not necessary to add a resistor, the increase in area can be reduced to a greater extent than those of conventional techniques. Moreover, the power of N non-selected differential amplifier transistor pairs can be reduced to several picoamperes or less (substantially zero). Thus, the increase in power consumption and area which is caused by addition of a resistor can be prevented.

The selection of M differential amplifier transistor pairs having a predetermined output voltage accuracy from the (M+N) differential amplifier transistor pairs (Mp₁, Mn₁)-(Mp_{M+N}, Mn_{M+N}) to form M operational amplifiers means selection of operational amplifiers including transistors having a small mismatch. Therefore, variations caused by temperature or power supply are also variations of similar transistors, and therefore, substantially do not occur. As a result, variations in offset voltage caused by variations in power supply voltage or temperature can be reduced.

Moreover, only M active loads and M output driver/current mirror sections need to be provided. Therefore, compared to the first embodiment, N active loads and N output driver/current mirror sections can be removed. Note that the output driver/current mirror section includes a phase compensation capacitor whose area is larger than those of other components, and therefore, the reduction in a region where the phase compensation capacitor is formed greatly contributes to the reduction in the area of the data line drive circuit.

(Second Variation of First Embodiment)

In the first embodiment, N redundant operational amplifiers are previously prepared in the drive amplifier SAMP, and M operational amplifiers having a predetermined output voltage accuracy are selected from (M+N) operational amplifiers AP₁-AP_{M+N}. In a second variation of the first embodiment, N redundant differential amplifiers are previously prepared in the drive amplifier SAMP instead of providing redundant operational amplifiers themselves, and a control technique and a selection technique similar to those of the first embodiment are employed.

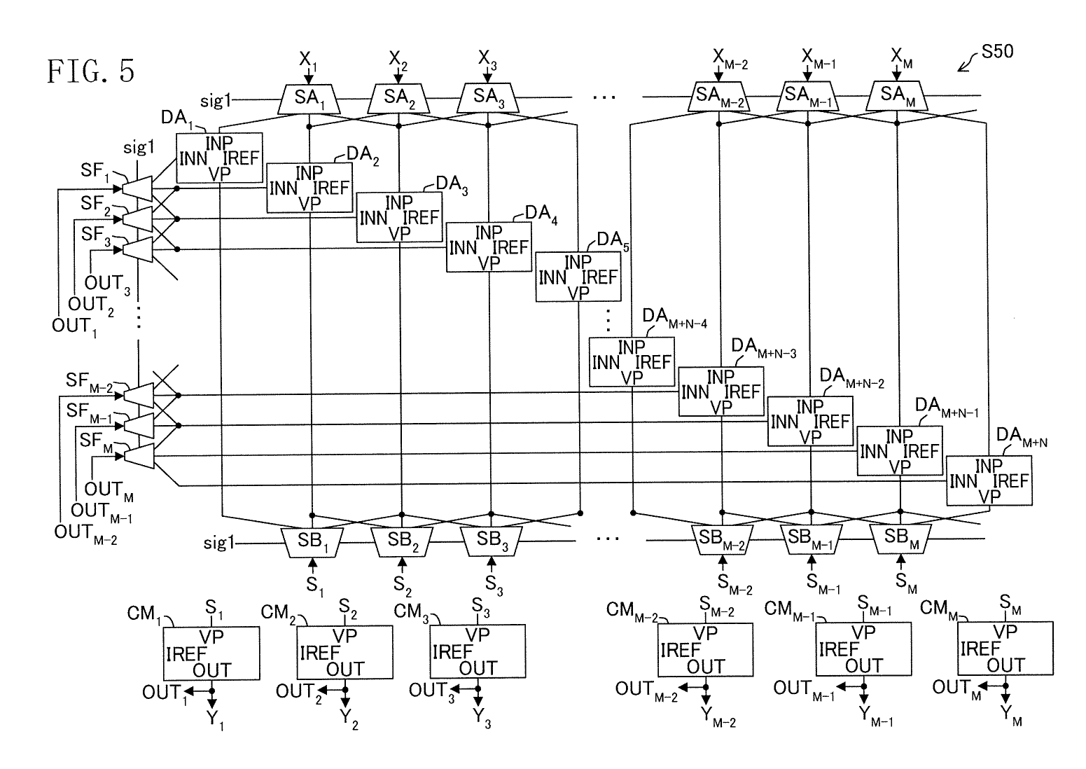

FIG. 5 shows a configuration of an amplifier circuit S50 according to the second variation of the first embodiment. The amplifier circuit S50 includes M selectors SA₁-SA_{M}, M selectors SB₁-SB_{M}, M selectors SI₁-SI_{M}, M selectors SF₁-SF_{M}, (M+N) differential amplifiers DA₁-DA_{M+N}, and M output driver/current mirror sections CM₁-CM_{M}. Note that, similar to the first embodiment, in FIG. 5, a case where N=2 is shown for ease of understanding.

The selectors SA₁-SA_{M} correspond to the display voltages X₁-X_{M}, respectively. The i-th selector SAᵢ (i=1, . . . , M) receives the i-th display voltage Xᵢ (i=1, . . . , M) corresponding to the selector SAᵢ. The selectors SA₁-SA_{M} are each a selector having one input and (N+1) outputs. The (N+1) output terminals of the selector SAᵢ (i=1, . . . , M) are connected to terminals INP of the i-th to (i+N)th differential amplifiers DAᵢ-DA_{i+N} (i=1, . . . , M), respectively. The selector SAᵢ (i=1, . . . , M) selectively outputs the display voltage Xᵢ (i=1, . . . , M) from one of the (N+1) output terminals of the selector SAᵢ in response to the select signal sig1.

The selectors SF₁-SF_{M} correspond to the output voltages OUT₁-OUT_{M} of the output driver/current mirror sections CM₁-CM_{M}, respectively. The i-th selector SFᵢ (i=1, . . . , M) receives the i-th output voltage OUTᵢ (i=1, . . . , M) corresponding to the selector SFᵢ. The selectors SF₁-SF_{M} are each a selector having one input and (N+1) outputs. The (N+1) output terminals of the selector SFᵢ (i=1, . . . , M) are connected to terminals INN of the i-th to (i+N)th differential amplifiers DAᵢ-DA_{i+N} (i=1, . . . , M), respectively. The selector SFᵢ (i=1, . . . , M) selectively outputs the output voltage OUTᵢ (i=1, . . . , M) corresponding to the selector SFᵢ from one of the (N+1) output terminals of the selector SFᵢ in response to the select signal sig1.

The selectors SB₁-SB_{M} correspond to the selectors SA₁-SA_{M}, respectively. The selectors SB₁-SB_{M} are each a selector having (N+1) inputs and one output. The (N+1) input terminals of the i-th selector SBᵢ (i=1, . . . , M) are connected to the terminals VP of the i-th to (i+N)th differential amplifiers DAᵢ-DA_{i+N} (i=1, . . . , M), respectively. The selector SBᵢ (i=1, . . . , M) selectively connects one of the (N+1) input terminals of the selector SBᵢ to the terminal VP of the i-th the output driver/current mirror section CMᵢ in response to the select signal sig1. The output voltage Sᵢ (i=1, . . . , M) of the selector SBᵢ (i=1, . . . , M) is supplied to the terminal VP of the output driver/current mirror section CMᵢ (i=1, . . . , M). The output driver/current mirror section CMᵢ (i=1, . . . , M) is an output circuit for an operational amplifier. The output driver/current mirror section CMᵢ (i=1, . . . , M) can operate as an operational amplifier by connecting to one of the differential amplifiers DA₁-DA_{M+N}.

[Differential Amplifier]

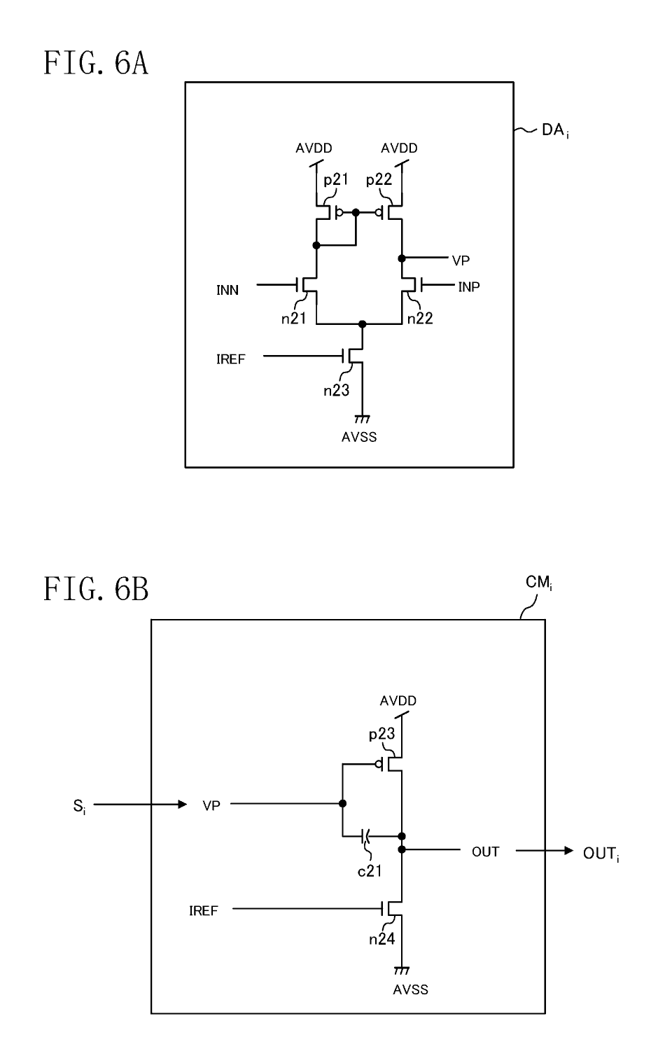

FIG. 6A shows an example configuration of the differential amplifier DAᵢ (i=1, . . . , M) of FIG. 5. The differential amplifier DAᵢ includes a pair of P-channel transistors (p21, p22), a pair of N-channel transistors (n21, n22), and an N-channel transistor n23. The P-channel transistors (p21, p22) form an active load. The pair of N-channel transistors (n21, n22) is connected to the pair of P-channel transistors (p21, p22). The N-channel transistor n23 supplies a bias current to the pair of N-channel transistors (n21, n22). The P-channel transistor p21 is diode-connected. The gate terminal of the P-channel transistor p22 is connected to the gate terminal of the P-channel transistor p21. The drain terminal of the P-channel transistor p22 and the N-channel transistor n22 is connected to the terminal VP of the differential amplifier DAᵢ. The gate terminals of the N-channel transistors n21, n22, and n23 are connected to the terminals INN, INP, and IREF of the differential amplifier DAᵢ, respectively. Note that a bias voltage is input to the terminal IREF of the differential amplifier DAᵢ.

[Output Driver/Current Mirror Section]

FIG. 6B shows an example configuration of the output driver/current mirror section CMᵢ (i=1, . . . , M) of FIG. 5. The output driver/current mirror section CMᵢ includes a P-channel transistor p23 connected between a power supply node to which a power supply voltage AVDD is input and an output terminal OUT, a phase compensation capacitor C21, and an N-channel transistor n24 connected between a ground node to which a ground voltage AVSS is input and an output terminal OUT. The gate terminal of the N-channel transistor n24 is connected to a terminal IREF to which a bias voltage is input. The N-channel transistor n24 receives, at the gate terminal, the bias voltage via the terminal IREF to generate a bias current. The gate terminal of the P-channel transistor p23 is connected to a terminal VP of the output driver/current mirror section CMᵢ. An output voltage OUTᵢ is generated at the output terminal OUT. The phase compensation capacitor C21 is connected between the gate terminal of the P-channel transistor p23 and the output terminal OUT.

[Operation]

Next, operation of the amplifier circuit S50 of FIG. 5 will be described. Here, it is assumed that, of the differential amplifiers DA₁-DA_{M+N}, the differential amplifier DA₂ is defective (i.e., have a large variation in the threshold voltage to cause an offset voltage), and the other differential amplifiers do not have a problem (i.e., transistors included in the differential amplifier do not have a fabrication variation).

When the data line drive circuit 100 including the amplifier circuit S50 of FIG. 5 is activated, the select signal sig1 is initially input to the selectors SA₁, SB₁, and SF₁ so that the first differential amplifier DA₁ is selected. As a result, the differential amplifier DA₁ and the output driver/current mirror section CM₁ can operate in a manner similar to that of the operational amplifier AP₁ of FIG. 2. In this situation, when the display voltage X₁ is input to the selector SA₁, the differential amplifier DA₁ and the output driver/current mirror section CM₁ perform impedance conversion on the display voltage X₁ to output, as the drive voltage Y₁, a voltage having a voltage level equal to that of the display voltage X₁. Here, because the transistors included in the differential amplifier DA₁ are not defective, the drive voltage Y₁ having a value substantially equal to the expected value is obtained. Thereafter, it is determined to select the differential amplifier DA₁, and the address (select value) of the differential amplifier DA₁ is stored in an external storage device so that the differential amplifier DA₁ is selected by the selectors SA₁, SB₁, and SF₁.

Next, the select signal sig1 is input to the selectors SA₂, SB₂, and SF₂ so that the second differential amplifier DA₂ is selected. As a result, the differential amplifier DA₂ and the output driver/current mirror section CM₂ can operate in a manner similar to that of the operational amplifier AP₂ of FIG. 2. In this situation, however, even if the display voltage X₂ is input to the selector SA₂, the differential amplifier DA₂ and the output driver/current mirror section CM₂ cannot normally perform impedance conversion on the display voltage X₂, and cannot output the drive voltage Y₂ having a level equal to that of the display voltage X₂. This is because the differential amplifier DA₂ includes a defective transistor.

In this case, the select signal sig1 is also input to the selectors SA₂, SB₂, and SF₂ so that the third differential amplifier DA₃ is selected. As a result, the differential amplifier

DA₃ and the output driver/current mirror section CM₂ can operate in a manner similar to that of the operational amplifier AP₃ of FIG. 2.

In this situation, when the display voltage X₂ is input, the differential amplifier DA₃ and the output driver/current mirror section CM₂ perform impedance conversion on the display voltage X₂ to output, as the drive voltage Y₂, a voltage having a voltage level equal to that of the display voltage X₂. Here, because the transistors included in the differential amplifier DA₃ are not defective, the drive voltage Y₂ having a value substantially equal to the expected value is obtained. Thereafter, it is determined to select the differential amplifier DA₃, and the address (select value) of the differential amplifier DA₃ is stored in an external storage device so that the differential amplifier DA₃ is selected by the selectors SA₂, SB₂, and SF₂.

By repeatedly performing such operation, M addresses excluding those of differential amplifiers including defective transistors can be stored in a storage device. When displaying, only M addresses excluding those of differential amplifiers including defective transistors are input, whereby M operational amplifiers which do not have a variation in characteristic can be configured.

As described above, M differential amplifiers having a predetermined output voltage accuracy are selected from the (M+N) differential amplifiers DA₁-DA_{M+N} to form M operational amplifiers, whereby the accuracies of M output voltages Y₁-Y_{M} can be increased.

Moreover, unlike conventional techniques, a resistor etc. is not used to increase the accuracy, and therefore, an extra current does not occur. Because it is not necessary to add a resistor, the increase in area can be reduced to a greater extent than those of conventional techniques. Moreover, the power of N non-selected differential amplifiers can be reduced to several picoamperes or less (substantially zero). Thus, the increase in power consumption and area which is caused by addition of a resistor can be prevented.

The selection of M differential amplifiers having a predetermined output voltage accuracy from the (M+N) differential amplifiers DA₁-DA_{M+N} to form M operational amplifiers means selection of operational amplifiers including transistors having a small mismatch. Therefore, variations caused by temperature or power supply are also variations of similar transistors, and therefore, substantially do not occur. As a result, variations in offset voltage caused by variations in power supply voltage or temperature can be reduced.

Moreover, M output driver/current mirror sections CMᵢ only need to be provided. Therefore, compared to the first embodiment, N output driver/current mirror sections can be removed. Note that the output driver/current mirror section includes a phase compensation capacitor whose area is larger than those of other components, and therefore, the reduction in a region where the phase compensation capacitor is formed greatly contributes to the reduction in the area of the data line drive circuit.

Moreover, if the differential amplifiers DAᵢ are formed as a group on silicon, the complexity of interconnection and arrangement is reduced compared to the first variation in which an N-channel transistor included in a differential amplifier pair and a P-channel transistor included in an active load are separately selected. Therefore, a symmetric arrangement having a short interconnection length can be achieved. Therefore, the parasitic capacitance is smaller than that of the first variation. As a result, operation having high speed and operation having high oscillation stability can be achieved.

### Second Embodiment

The entire configuration of a data line drive circuit 100 according to a second embodiment is similar to that of the first embodiment (FIG. 1A), except for the internal configuration of the amplifier circuit S50.

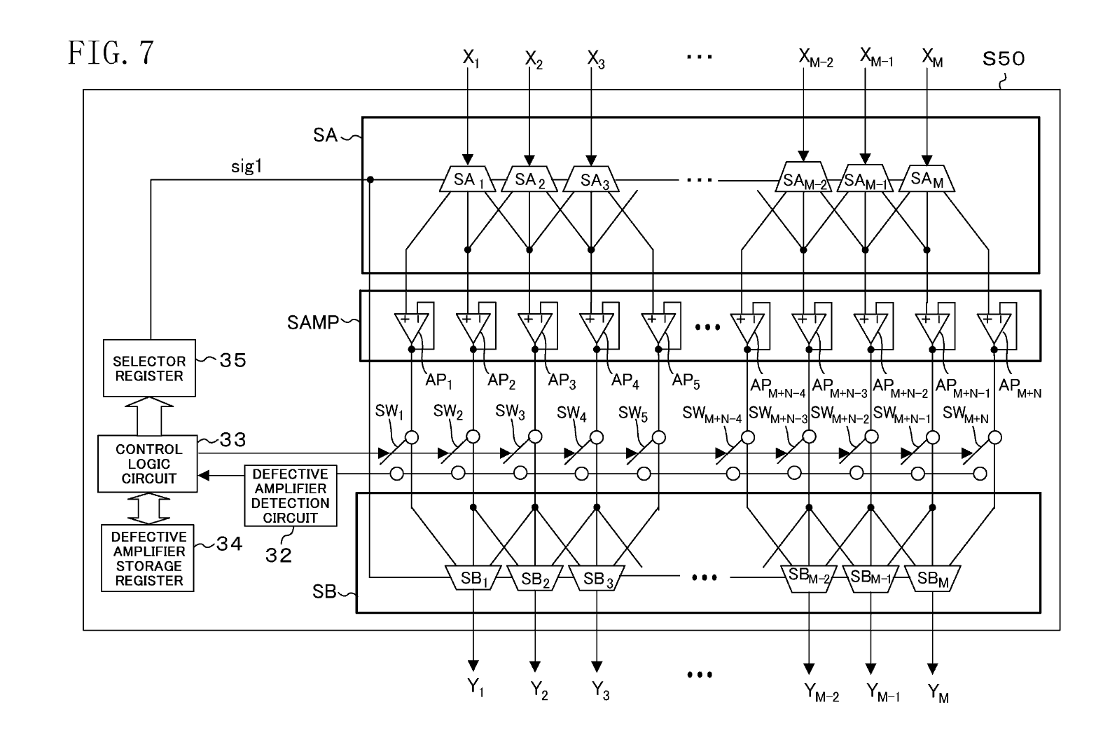

FIG. 7 shows an example configuration of the amplifier circuit S50 of the second embodiment. The amplifier circuit S50 includes an input selector SA, a drive amplifier SAMP, an output selector SB, (M+N) switches SW₁-SW_{M+N}, a defective amplifier detection circuit 32, a control logic circuit 33, a defective amplifier storage register 34, and a selector register 35. Note that, also in FIG. 7, a case where N=2 is shown for ease of understanding. The input selector SA includes M selectors SA₁-SA_{M}. The selectors SA₁-SA_{M} correspond to display voltages X₁-X_{M}, respectively. The i-th selector SAᵢ (i=1, . . . , M) receives the i-th display voltage Xᵢ (i=1, . . . , M) corresponding to the selector SAᵢ. The selectors SA₁-SA_{M} are each a selector having one input and (N+1) outputs. The selector SAᵢ (i=1, . . . , M) selectively outputs the display voltage Xᵢ (i=1, . . . , M) from one of the (N+1) output terminals of the selector SAᵢ in response to a select signal sig1.

The drive amplifier SAMP includes (M+N) operational amplifiers AP₁-AP_{M+N} each configured as a voltage follower. Also here, similar to the first embodiment, defective accuracy is previously assumed to occur at some frequency, and N redundant operational amplifiers for replacement are provided, i.e., (M+N) operational amplifiers AP₁-AP_{M+N}, the number of which is larger by N than the number (M) of the output voltages Y₁-Y_{M}, are provided, in the drive amplifier SAMP.

The output selector SB includes M selectors SB₁-SB_{M}. The selectors SB₁-SB_{M} correspond to M data lines D₁-D_{M} of a display panel, respectively. The i-th data line Dᵢ (i=1, . . . , M) corresponding to the selector SBᵢ is driven based on the i-th drive voltage Yᵢ (i=1, . . . , M) output from the i-th selector SBᵢ (i=1, . . . , M). The selectors SB₁-SB_{M} are each a selector having (N+1) inputs and one output. The selector SBᵢ (i=1, . . . , M) selectively outputs, as the i-th drive voltage Yᵢ, a voltage input to one of the (N+1) input terminals of the selector SBᵢ in response to the select signal sig1.

One of the (N+1) output terminals of the i-th selector SAᵢ (i=1, . . . , M) of the input selector SA is connected to the non-inverting input terminal (+) of the i-th operational amplifier APᵢ (i=1, . . . , M), while the remaining N output terminals are connected to the non-inverting input terminals (+) of the (i+1)th to (i+N)th operational amplifiers APᵢ₊₁-AP_{i+N=}1, . . . , M), respectively.

One of the (N+1) input terminals of the i-th selector SBᵢ (i=1, . . . , M) of the output selector SB is connected to the output terminal of the i-th operational amplifier APᵢ (i=1, . . . , M), while the remaining N input terminals are connected to the output terminals of the (i+1)th to (i+N)th operational amplifiers APᵢ₊₁-AP_{i+N} (i=1, . . . , M), respectively.

The switches SW₁-SW_{M+N} correspond to the operational amplifiers AP₁-AP_{M+N}, respectively. The i-th switch SWᵢ (i=1, . . . , M+N) enables/disables supply of the output of the i-th operational amplifier APᵢ (i=1, . . . , M+N) corresponding to the switch SWᵢ to the defective amplifier detection circuit 32 in response to a control signal from the control logic circuit 33.

The defective amplifier detection circuit 32 and the control logic circuit 33 determine whether or not each of the (M+N) operational amplifiers AP₁-AP_{M+N} has a predetermined output voltage accuracy (e.g., a voltage accuracy lower than or equal to the difference between each gray level of the gray-scale voltage). The defective amplifier storage register 34 includes N registers. Each of the N registers can store information of (1+log₂M) bits. Each register stores the address of an operational amplifier which has been determined to be defective by the defective amplifier detection circuit 32 (an operational amplifier which does not have the predetermined output voltage accuracy). The selector register 35 includes M registers. Each of the M registers can store information of (1+log₂(N+1)) bits. M register values stored in the M registers correspond to the M selectors SA₁-SA_{M} and the M selectors SB₁-SB_{M}, respectively. The selector register 35 also generates the select signal sig1 based on the M register values.

[Operation]

Next, operation of the data line drive circuit 100 according to the second embodiment will be described.

Virtual addresses are assigned to the operational amplifiers AP₁-AP_{M+N} of the drive amplifier SAMP, the selectors SA₁-SA_{M} of the input selector SA, and the selectors SB₁-SB_{M} of the output selector SB. The virtual address is successively incremented from one end in one direction of the physical arrangement. Here, it is assumed that addresses 1-(M+N) are assigned to the operational amplifiers AP₁-AP_{M+N} of the drive amplifier SAMP, respectively, addresses 1-M are assigned to the selectors SA₁-SA_{M} of the input selector SA, respectively, and addresses 1-M are assigned to the selectors SB₁-SB_{M} of the output selector SB, respectively.

A process (step 1) of detecting an operational amplifier which does not have a predetermined output voltage accuracy from the (M+N) operational amplifiers AP₁-AP_{M+N} storing information about the operational amplifier and a process (step 2) of configuring M operational amplifiers, will be described hereinafter.

<<Step 1>>

In step 1, the control logic circuit 33 successively switches on the switches SW₁-SW_{M+N} from the switch SW₁ corresponding to the operational amplifier AP₁ to which the smallest address is assigned, to successively input the outputs of the operational amplifiers AP₁-AP_{M+N} to the defective amplifier detection circuit 32. Every time the defective amplifier detection circuit 32 receives the output of an operational amplifier, the defective amplifier detection circuit 32 determines whether or not the operational amplifier is defective.

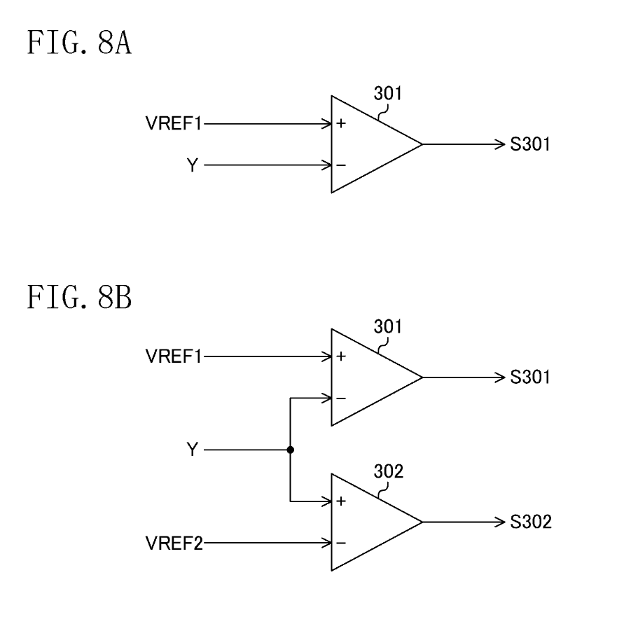

Note that, as shown in FIG. 8A, the defective amplifier detection circuit 32 may include a comparator 301. In this case, a predetermined one(s) of the gray-scale voltages of the gray-scale voltage generator circuit 60 is input as the display voltages X₁-X_{M} to the non-inverting input terminals (+) of the operational amplifiers AP₁-AP_{M+N}. The output voltage

Y of one of the operational amplifiers AP₁-AP_{M+N} (an operational amplifier selected by the control logic circuit 33) is input to one of the input terminals of the comparator 301, while a reference voltage VREF1 which is higher by half the difference between each gray level than the predetermined gray-scale voltage (the gray-scale voltage input to the non-inverting input terminals (+) of the operational amplifiers AP₁-AP_{M+N}) is input to the other input terminal of the comparator 301. With this configuration, it is possible to determine whether or not the operational amplifiers AP₁-AP_{M+N} have a voltage accuracy which is lower than or equal to half the difference between each gray level (whether or not the output error of the operational amplifier falls within an error range which is narrower than half the difference between each gray level). For example, when an output S301 of the comparator 301 is at a high level, it is determined that the operational amplifier has the predetermined output voltage accuracy, and when the output S301 of the comparator 301 is at a low level, it is determined that the operational amplifier does not have the predetermined output voltage accuracy.

Alternatively, as shown in FIG. 8B, the defective amplifier detection circuit 32 may include comparators 301 and 302. In this case, the output voltage Y of one of the operational amplifiers AP₁-AP_{M+N} is input to one of the input terminals of the comparator 302, while a reference voltage VREF2 which is lower by half the difference between each gray level than the predetermined gray-scale voltage is input to the other input terminal of the comparator 302. With this configuration, it is possible to determine whether or not the operational amplifiers AP₁-AP_{M+N} have a voltage accuracy which is lower than or equal to half the difference between each gray level (whether or not the output error of the operational amplifier falls within an error range which is narrower than half the difference between each gray level). For example, when outputs S301 and S302 of the comparators 301 and 302 are both at a high level, it is determined that the operational amplifier has the predetermined output voltage accuracy, and when one of the outputs S301 and S302 of the comparators 301 and 302 is at a low level, it is determined that the operational amplifier does not have the predetermined output voltage accuracy. Note that the defective amplifier detection circuit 32 may include only the comparator 302.

Next, the control logic circuit 33 stores, to the defective amplifier storage register 34, the address of one(s) of the operational amplifiers AP₁-AP_{M+N} that has been determined to be defective by the defective amplifier detection circuit 32. Note that if the number of defective amplifiers exceeds N, not all the defective amplifiers are replaced. However, as described in the first embodiment, the number (N) of redundant operational amplifiers may be selective.

<<Step 2>>

Next, in step 2, select values (M register values of the selector register 35) for the input selector SA and the output selector SB are determined. The register values of the selector register 35 and operational amplifiers which are to be selected by the selectors are assumed to have the following relationship. Specifically, it is assumed that the M register values of the selector register 35 correspond to the M selectors SA₁-SA_{M} and the M selectors SB₁-SB_{M}, respectively, and have an initial value of “0.” When all the M register values are set to the initial value (=0), the i-th selectors SAᵢ and SBᵢ (i=1, . . . , M) select the i-th operational amplifier APᵢ to which the same address as that of the selectors SAᵢ and SBᵢ has been assigned. It is also assumed that when the i-th register value is incremented, the i-th selectors SAᵢ and SBᵢ (i=1, . . . , M) corresponding to the register value select the (i+1)th operational amplifier APᵢ₊₁ immediately next to the i-th operational amplifier APᵢ.

In the above relationship, the M register values of the selector register 35 are set by the following procedure.

The control logic circuit 33 determines whether or not the first operational amplifier AP₁ is defective, by referencing the defective amplifier storage register 34. If the first operational amplifier AP₁ is not defective, the control logic circuit 33 maintains the register value corresponding to the first selectors SA₁ and SB₁ at the initial value (=0). Note that when none of the (M+N) operational amplifiers AP₁-AP_{M+N} is defective, all the M register values of the selector register 35 are maintained at the initial value (=0). Specifically, the selectors SA₁-SA_{M} and the selectors SB₁-SB_{M} select the operational amplifiers AP₁-AP_{M} to which the same addresses (1-M) as those of the selectors SA₁-SA_{M} (SB₁-SB_{M}) have been assigned, respectively.

On the other hand, if the first operational amplifier AP₁ is defective, the control logic circuit 33 does not determine a register value corresponding to the first selectors SA₁ and SBᵢ, and increments the count value (=0) of an internal counter of the control logic circuit 33, so that the count value is “1.” Thereafter, the control logic circuit 33 determines whether or not the second operational amplifier AP₂ is defective, by referencing the defective amplifier storage register 34. If the second operational amplifier AP₂ is not defective, the control logic circuit 33 sets the register value corresponding to the first selectors SA₁ and SB₁ to the count value (=1) of the internal counter. Note that if none of the third operational amplifier and thereafter (AP₃-AP_{M+N}) is defective, the remaining (M−1) register values are all set to the count value (=1) of the internal counter. Specifically, the selectors SA₁-SA_{M} and the selectors SB₁-SB_{M} select the operational amplifiers AP₂-AP_{M+1} to which addresses (2−(M+1)) which are larger by one than the addresses of the selectors SA₁-SA_{M} (SB₁-SB_{M}) have been assigned, respectively.

On the other hand, if the second operational amplifier AP₁ is defective, the control logic circuit 33 does not determine a register value corresponding to the first selectors SA₁ and SB₁, and increments the count value (=1) of the internal counter of the control logic circuit 33, so that the count value of the internal counter is “2.” Thereafter, the control logic circuit 33 determines whether or not the third operational amplifier AP₃ is defective, by referencing the defective amplifier storage register 34. If the third operational amplifier AP₃ is not defective, the control logic circuit 33 sets the register value corresponding to the first selectors SA₁ and SB₁ to the count value (=2) of the internal counter. Note that if none of the fourth operational amplifier and thereafter (AP₄-AP_{M+N}) is defective, the remaining (M−1) register values are all set to the count value (=2) of the internal counter. Specifically, the selectors SA₁-SA_{M} and the selectors SB₁-SB_{M} select the operational amplifiers AP₃-AP_{M+2} to which addresses (3−(M+2)) which are larger by two than the addresses of the selectors SA₁-SA_{M} (SB₁-SB_{M}) have been assigned.

By the above operation (steps 1 and 2), a defective amplifier is not selected, but a non-defective operational amplifier which is adjacent thereto is selected. Note that a total of

N defective amplifiers can be simultaneously replaced.

[Specific Example]

Next, an example of the above operation where M=1000 and N=100 will be described. Here, it is assumed that the addresses of the drive amplifier SAMP are 1-1100, and the addresses of the input selector SA and the output selector SB are 1-1000. Note that, for the sake of simplicity, it is assumed that the operational amplifiers AP₅₀₀ and AP₇₅₀ at addresses 500 and 750 are defective.

<<Step 1>>

In step 1, the control logic circuit 33 successively switches on the switches SW₁-SW₁₀₀₀ from the switch SWᵢ corresponding to address 1, and the defective amplifier detection circuit 32 determines whether or not each of the operational amplifiers AP₁-AP₁₀₀₀ is defective. Here, it is determined that the operational amplifiers AP₅₀₀ and AP₇₅₀ at addresses 500 and 750 are defective, and the defective amplifier storage register 34 stores addresses 500 and 750.

<<Step 2 Addresses 1-499>>

Next, in step 2, the control logic circuit 33 determines that the operational amplifier AP₁ at address 1 is not defective, by referencing the defective amplifier storage register 34, and maintains one corresponding to the selectors SA₁ and SB₁ at address 1 of M register values of the selector register 35 at the initial value (=0). Thereafter, processes similar to this process are performed. The control logic circuit 33 maintains register values corresponding to the selectors SA₂-SA₄₉₉ and SB₂-SB₄₉₉ at addresses 2-499 at the initial value (=0).

<<Step 2 Addresses 500-749>>

Next, because the defective amplifier storage register 34 stores address 500, the control logic circuit 33 determines that the operational amplifier AP₅₀₀ at address 500 is defective, and does not determine a register value corresponding to the selectors SA₅₀₀ and SB₅₀₀ at address 500, and increments the count value (initial value: 0) of the internal counter in the control logic circuit 33 to “1.”

Next, the control logic circuit 33 determines that the operational amplifier AP₅₀₁ at address 501 is not defective, and sets the undetermined register value corresponding to the selectors SA₅₀₀ and SB₅₀₀ at address 500 to the count value (=1) of the internal counter. In this case, the control logic circuit 33 does not determine a register value corresponding to the selectors SA₅₀₁ and SB₅₀₁ at address 501.

Next, the control logic circuit 33 determines that the operational amplifier AP₅₀₂ at address 502 is not defective, and sets the undetermined register value corresponding to the selectors SA₅₀₁ and SB₅₀₁ at address 501 to the count value (=1) of the internal counter. Thereafter, processes similar to this process are performed. The control logic circuit 33 sets register values corresponding to the selectors SA₅₀₂-SA₇₄₈ and SB₅₀₂-SB₇₄₈ at addresses 502-748 to the initial value (=1).

<<Step 2 Addresses 750-1000>>

Next, because the defective amplifier storage register 34 stores address 750, the control logic circuit 33 determines that the operational amplifier AP₇₅₀ at address 750 is defective, does not determine a register value corresponding to the selectors SA₇₄₉ and SB₇₄₉ at address 749, and increments the count value (=1) of the internal counter in the control logic circuit 33 to “2.”

Next, the control logic circuit 33 determines that the operational amplifier AP₇₅₁ at address 751 is not defective, and sets the undetermined register value corresponding to the selectors SA₇₄₉ and SB₇₄₉ at address 749 to the count value (=2) of the internal counter.

Next, the control logic circuit 33 determines that the operational amplifier AP₇₅₂ at address 752 is not defective, and sets the undetermined register value corresponding to the selectors SA₇₅₀ and SB₇₅₀ at address 750 to the count value (=2) of the internal counter. Thereafter, processes similar to this process are performed. The control logic circuit 33 sets register values corresponding to the selectors SA₇₅₁-SA₁₀₀₀ and SB₇₅₁-SB₁₀₀₀ at addresses 751-1000 to the count value (=2) of the internal counter.

By the above operation, M operational amplifiers having a predetermined output voltage accuracy are selected from the (M+N) operational amplifiers AP₁-AP_{M+N}.

As described above, M operational amplifiers having a predetermined output voltage accuracy are selected from the (M+N) operational amplifiers AP₁-AP_{M+N} and are used, whereby the accuracy of the M drive voltages Y₁-Y_{M} can be increased.

Moreover, unlike conventional techniques, a resistor etc. is not used to increase the accuracy, and therefore, an extra current does not occur. Because it is not necessary to add a resistor, the increase in area can be reduced to a greater extent than those of conventional techniques. Moreover, the power of a non-selected operational amplifier can be reduced to several picoamperes or less (substantially zero). Thus, the increase in power consumption and area which is caused by addition of a resistor can be prevented.

The selection of M operational amplifiers having a predetermined output voltage accuracy from the (M+N) operational amplifiers AP₁-AP_{M+N} means selection of operational amplifiers including transistors having a small mismatch. Therefore, variations caused by temperature or power supply are also variations of similar transistors, and therefore, substantially do not occur. As a result, variations in offset voltage caused by variations in power supply voltage or temperature can be reduced.

Moreover, compared to the first embodiment, the data line drive circuit 100 includes the defective amplifier detection circuit 32, the defective amplifier storage register 34, the control logic circuit 33, and the selector register 35, resulting in a simpler system configuration. In the first embodiment, the circuit for storing the address of an operational amplifier which does not have a predetermined output voltage accuracy is provided outside the data line drive circuit 100, whereby the data line drive circuit 100 can have a compact configuration. However, when the data line drive circuit 100 is used in a display panel system, additional parts and a semiconductor device for storing the addresses of operational amplifiers need to be provided outside the data line drive circuit 100, so that the system becomes more complicated. In contrast to this, in the second embodiment, the entire panel system can have a simpler configuration.

Note that, similar to the first embodiment, the (M+N) operational amplifiers AP₁-AP_{M+N} each configured as a voltage follower are described as an example drive circuit only for illustrative purposes. Alternatively, (M+N) other negative-feedback circuits (e.g., an inverting amplifier, a non-inverting amplifier, etc.) may be used.

### Third Embodiment

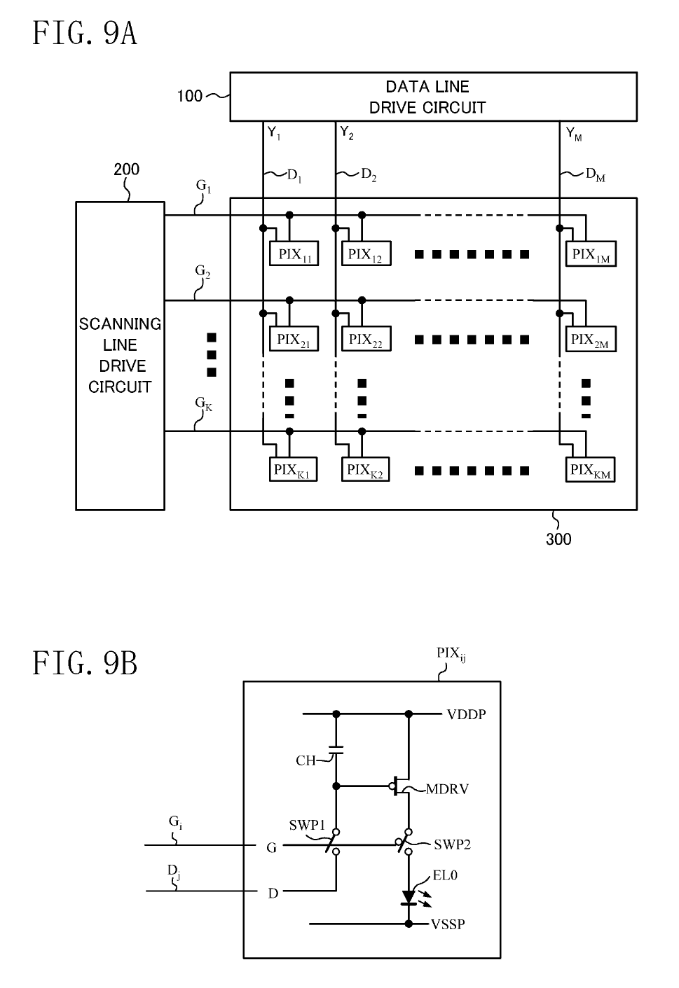

FIG. 9A shows a configuration of a display device according to a third embodiment. The display device includes a data line drive circuit 100, a scanning line drive circuit 200, and a display panel 300. The scanning line drive circuit 200 generates and supplies a gate signal to K gate signal lines G₁-G_{K}. The data line drive circuit 100 supplies M drive voltages Y₁-Y_{M} to M data signal lines D₁-D_{M}, respectively. In this embodiment, as the data line drive circuit 100, one described in the first or second embodiment is used. The display panel 300 includes the M data signal lines D₁-D_{M}, the K gate signal lines G₁-G_{K}, and (K×M) pixel circuits PIX₁₁, PIX₁₂, . . . , PIX_{1M}, PIX₂₁, PIX₂₂, . . . , PIX_{2M}, . . . , PIX_{K1}, PIX_{K2}, . . . , and PIX_{KM}, each of which is controlled by one of the gate signal lines G₁-G_{K} and one of the data signal lines D₁-D_{M}. Note that the display panel 300 of FIG. 9A is an organic EL panel whose emission luminance is changed based on the drive voltages Y₁-Y_{M}. Alternatively, the display panel 300 may be a liquid crystal panel whose light transmittance is changed based on the drive voltages Y₁-Y_{M}.

[Pixel Circuit]

FIG. 9B shows a configuration of the pixel circuits PIXᵢⱼ (i=1, . . . , K and j=1, . . . , M). The pixel circuit PIXᵢⱼ includes a light emission device EL0, a transistor MDRV, a capacitor CH, and switches SWP1 and SWP2. The light emission of the light emission device EL0 is controlled based on a drive current supplied from the transistor MDRV. The switch SWP2 is connected between the transistor MDRV and the light emission device EL0 to control the supply of the drive current from the transistor MDRV to the light emission device EL0. The capacitor CH is connected between the gate terminal of the transistor MDRV and a power supply node to which a panel power supply VDDP is input, to hold the gate voltage of the transistor MDRV. The switch SWP1 controls the connection between the data signal line Dⱼ and the gate terminal of the transistor MDRV. The conductive and non-conductive states of the switches SWP1 and SWP2 are switched by the gate signal line

[Operation of Pixel Circuit]

Next, operation of the pixel circuit PIXᵢⱼ will be briefly described. The pixel circuit PIXᵢⱼ has two operation periods, i.e., a drive voltage supply period and an emission period.

During the drive voltage supply period, the switches SWP1 and SWP2 are set to the conductive state and the non-conductive state, respectively, by the gate signal line Gᵢ. As a result, the capacitor CH is charged by a drive voltage which is supplied from the data signal line Dⱼ to the pixel circuit PIXᵢⱼ. The light emission device EL0 is disconnected from the transistor MDRV, so that a drive current does not flow through the light emission device EL0, and therefore, the light emission device EL0 in this state does not emit light.

Next, during the emission period, the switches SWP1 and SWP2 are set to the non-conductive state and the conductive state, respectively, by the gate signal line As a result, the capacitor CH holds a voltage (drive voltage) which has been charged during the drive voltage supply period, i.e., the gate voltage of the transistor MDRV is held at the drive voltage. The transistor MDRV supplies a drive current corresponding to the gate voltage (drive voltage) via the switch SWP2 to the light emission device EL0. Thus, the light emission of the light emission device EL0 is controlled based on the drive current corresponding to the drive voltage.

[Displaying]

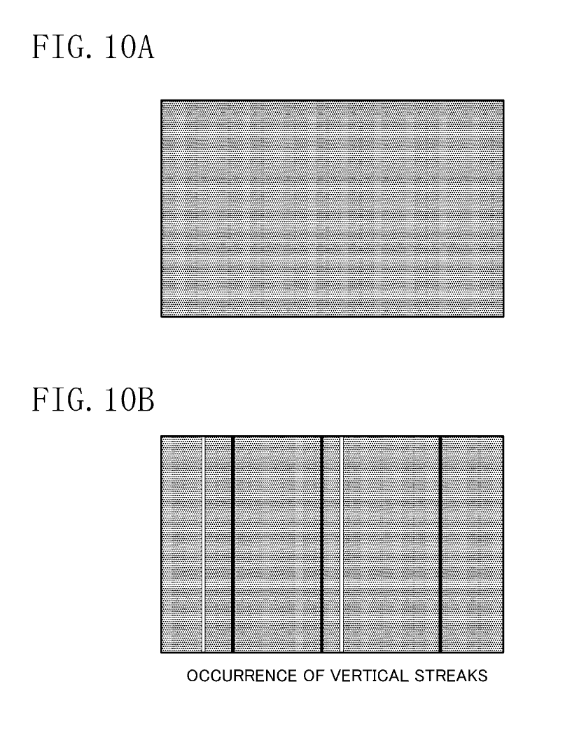

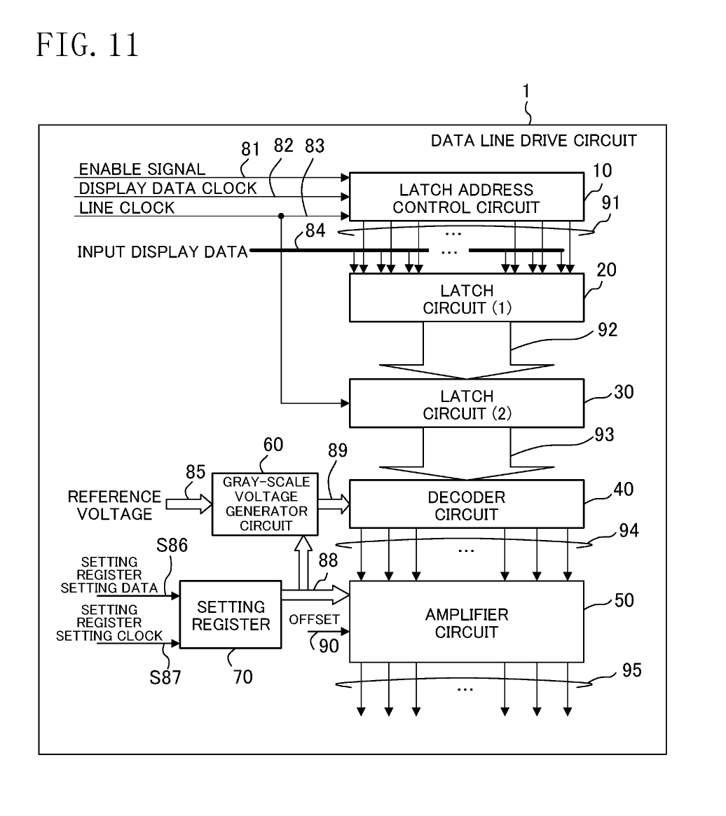

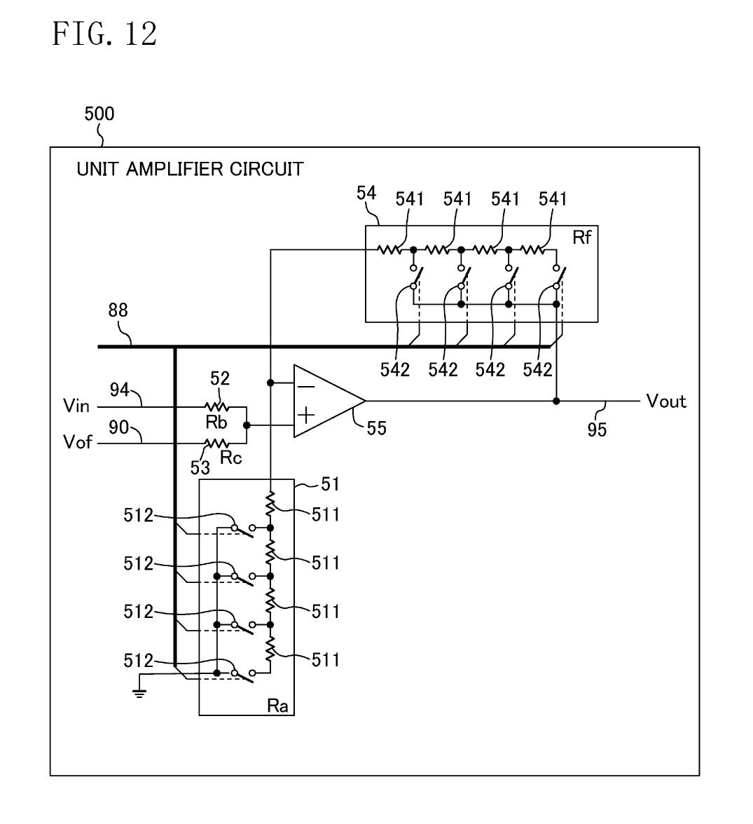

Next, what images displayed on the display device of FIG. 9A are like will be described with reference to FIGS. 10A and 10B. Here, an example in which a single color is displayed on the entire display screen (an image in which the luminance values of all pixel circuits are the same is displayed on the display panel 300) will be described.

FIG. 10A shows an ideal display state in which the data line drive circuit 100 supplies the drive voltages Y₁-Y_{M} having the same voltage value via the M data lines D₁-D_{M} to the (M×N) pixel circuits PIX₁₁, . . . , and PIX_{KM}, so that the pixel circuits PIX₁₁, . . . , and PIX_{KM} have the same luminance value.

FIG. 10B shows a display state in which there are variations between the drive voltages Y₁-Y_{M}. The pixel circuits PIX₁ᵢ-PIXₖᵢ connected to the i-th data signal line Dᵢ (i=1, . . . , M) are driven by the i-th drive voltage Y. Therefore, as shown in FIG. 10B, vertical streaks occur.

In the display device of this embodiment, however, the data line drive circuit 100 of the first or second embodiment is employed, and therefore, variations in the drive voltages Y₁-Y_{M} caused by an offset can be reduced, whereby a uniform display, such as that shown in FIG. 10A, can be obtained.

As described above, the data line drive circuit is useful for display devices, such as liquid crystal panels, organic EL panels, etc.

Note that the above embodiments are merely exemplary in nature and are in no way intended to limit the scope of the present disclosure, its application, or uses.

What is claimed is:

1. A data line drive circuit for outputting M drive voltages for driving M data lines of a display device, where M is an integer of two or more, comprising:
(M+N) drive circuits each configured to perform impedance conversion on an input voltage and output the resultant voltage, where n is an integer of one or more; and
a selector configured to select M drive circuits having a predetermined output voltage accuracy from the (M+N) drive circuits, supply M display voltages based on image data to be displayed on the display device to inputs of the selected M drive circuits, and output, as the M drive voltages, outputs of the selected M drive circuits, wherein
the (M+N) drive circuits include
(M+N) differential amplifier transistor pairs,
M active loads each configured to serve as an active load for an operational amplifier, and
M output driver/current mirror sections each configured to serve as an output circuit for an operational amplifier and as a current mirror circuit configured to input a bias to the corresponding differential amplifier transistor pair, and
M differential amplifier transistor pairs selected from the (M+N) differential amplifier transistor pairs by the selector, the M active loads, and the M output driver/current mirror sections form M negative feedback operational amplifiers.

2. A data line drive circuit for outputting M drive voltages for driving M data lines of a display device, where M is an integer of two or more, comprising:
(M+N) drive circuits each configured to perform impedance conversion on an input voltage and output the resultant voltage, where n is an integer of one or more; and
a selector configured to select M drive circuits having a predetermined output voltage accuracy from the (M+N) drive circuits, supply M display voltages based on image data to be displayed on the display device to inputs of the selected M drive circuits, and output, as the M drive voltages, outputs of the selected M drive circuits, wherein
the (M+N) drive circuits include
(M+N) differential amplifiers each configured to serve as a differential amplifier for an operational amplifier, and
M output driver/current mirror sections each configured to serve as an output circuit for an operational amplifier and as a current mirror circuit configured to input a bias to the corresponding differential amplifier transistor pair, and
M differential amplifiers selected from the (M+N) differential amplifiers by the selector and the M output driver/current mirror sections form M negative feedback operational amplifiers.

3. The data line drive circuit of claim 1, wherein
operation of N of the (M+N) drive circuits which have not been selected by the selector is stopped.

4. The data line drive circuit of claim 1, wherein
the (M+N) drive circuits are successively operated to select the M drive circuits having the predetermined output voltage accuracy.

5. A display device comprising:
the data line drive circuit of claim 1; and
a display panel configured to be driven based on the M drive voltages of the data line drive circuit.

6. The data line drive circuit of claim 2, wherein
operation of N of the (M+N) drive circuits which have not been selected by the selector is stopped.

7. The data line drive circuit of claim 2, wherein
the (M+N) drive circuits are successively operated to select the M drive circuits having the predetermined output voltage accuracy.

8. A display device comprising:
the data line drive circuit of claim 2; and
a display panel configured to be driven based on the M drive voltages of the data line drive circuit.
